(19) United States
(12) Patent Application Publication
(10) Pub. No.: US 2010/0117969 A1
(43) Pub. Date: May 13, 2010

(54) MONITORING ASSEMBLY EMBEDDED TO A PERSONAL COMPUTER FOR INCREASING OPERATION SPACE

(76) Inventor: Shih-Ming Shih, Taipei (TW)

Correspondence Address: Shih-Ming Shih, 235 Chung - Ho, Box 8-24, Taipei, 235, TW

(21) Appl. No.: 12/268,451

(22) Filed: Nov. 11, 2008

(51) Int. Cl. G06F 3/041

(52) U.S. Cl. 345/173

(57) ABSTRACT

A personal computer monitoring assembly by embedding a touch-controlling retaining seat to a personal computer for increasing a touch-controlling operation space includes following components. A retaining seat needs a least one receiving slot of a casing panel of a personal computer in installation. Each of two sides of the retaining seat is extended with an extension portion. A front end of the retaining seat has an opening and a back side of thereof is installed with a locking unit. A circuit substrate is formed with locking holes and a front side of the circuit substrate is installed with a monitoring display panel. A wire bus is extended from the circuit substrate and is connected to a touch panel, and a circuit interface is arranged to be connected to a computer mother board. A touch panel has a plurality of micro switch touch sensitive points.

### FIELD OF THE PRESENT INVENTION

The present invention relates to monitoring assemblies, and in particular to a monitoring assembly embedded to a personal computer so as to increasing the space for the operation.

### DESCRIPTION OF THE PRIOR ART

A computer front panel is formed with receiving slots for arranging the power switches, reset buttons, power indicators, and hard drive indicators for operating and displaying the status. The prior arrangement of the above components is simple without variation and also the indicator can not clearly provide the status of the computer such as the parameter of time, fan speed, or temperature, and also can not provide the function of modifying the parameter.

There are some non-touch-controlling monitoring systems capable of monitoring and modifying the status and the parameters of a personal computer such as time, fan speed, and temperature, but these products are arranged with switches of different functions which are easy to cause dirt to accumulate thereon and they are unattractive without shiny effect.

Therefore, the prior art generally has following defects.

1. The receiving slot arrangement of the prior art can not provide a complete and clearly displaying.

2. The receiving slot arrangement of the prior art is monotonous and it can not clearly indicate the status of the computer such as time, temperature and others.

3. The prior art using a non-touch-controlling method to monitor the status of the computer, but the buttons with different functions are easy to get dirt,

4. The prior non-touch-controlling system is monotonous and unattractive without a shiny effect.

### SUMMARY OF THE PRESENT INVENTION

Accordingly, the primary object of the present invention is to provide a monitoring assembly embedded to a personal computer so as to increasing the space for the operation.

A secondary object of the present invention is to provide a shiny effect through a touch-controlling method so as to indicate the computer status such as time, fan speed, and temperature. It is attractive and also provides parameters modifying function for the user.

To achieve above object, the present invention provides a personal computer monitoring assembly embedded to a personal computer with a touch-controlling retaining seat for increasing a touch-controlling operation space comprising: a retaining seat installed in at least one receiving slot of a personal computer and embedded into the receiving slot through an extension portion formed on two sides of the retaining seat; a front end of the retaining seat having an opening for receiving a monitoring display panel and for touch-controlling functions of the monitoring display panel; a back side of the retaining seat having a locking unit for locking a circuit substrate and a touch panel; a circuit substrate formed with locking holes; a front side of the circuit substrate installing with the monitoring display panel for providing a function of displaying, and a wire bus extending from the circuit substrate being connected to the touch panel; a circuit interface for connecting with to a computer mother board for controlling and data transfer; and a touch panel having a plurality of micro switch touch sensitive points for providing the user to operate the monitoring display panel.

The various objects and advantages of the present invention will be more readily understood, from the following detailed description when read in conjunction with the appended drawing.

### BRIEF DESCRIPTION OF THE DRAWINGS

FIG. 1 is a perspective and assembled schematic view of the present invention.

FIG. 2 is a structural exploded view of the present invention.

FIG. 3 is a backside structural schematic view of the present invention.

FIG. 4 is an installation schematic view of the present invention.

FIG. 5 is schematic view showing an embodiment about the installation of the present invention.

FIG. 6 is another schematic view showing an embodiment about the installation of the present invention,

FIG. 7 is another structural exploded view of the present invention.

FIG. 8 is another perspective and assembled schematic view showing an appearance of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

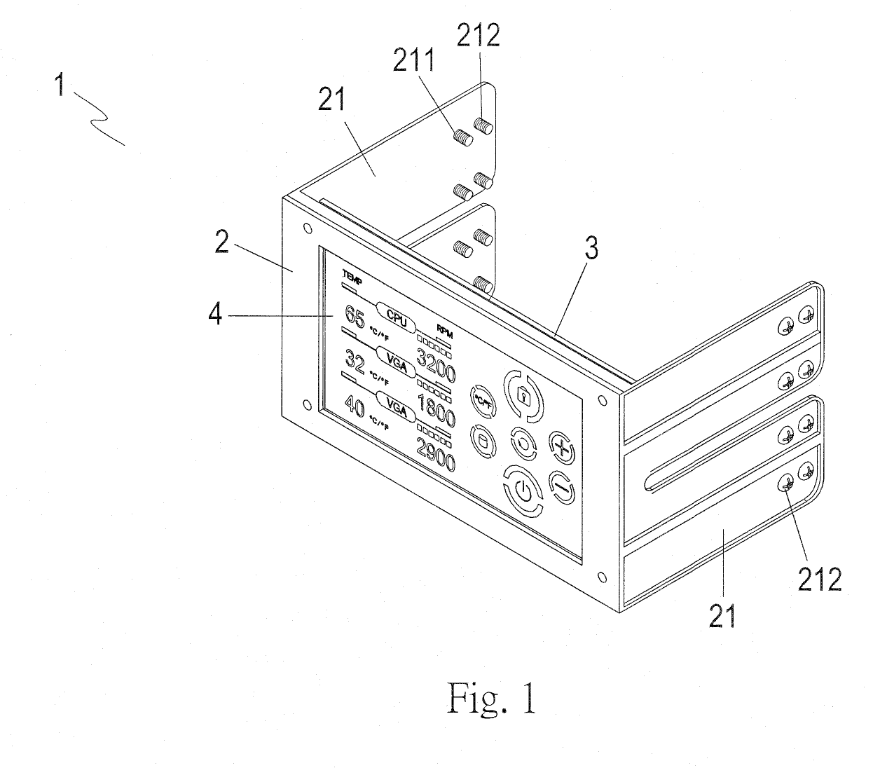

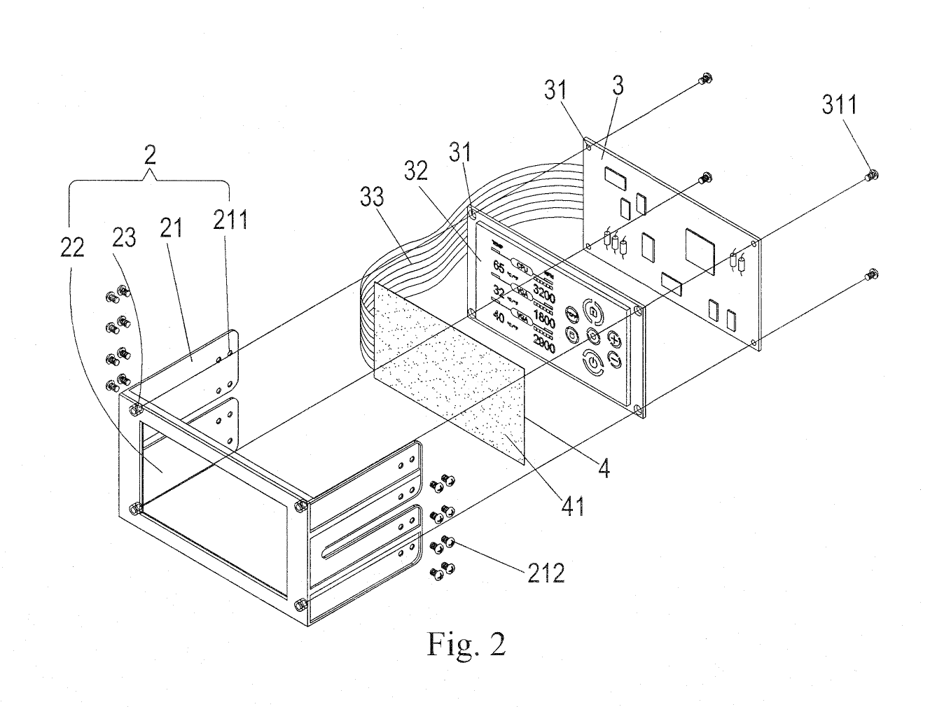

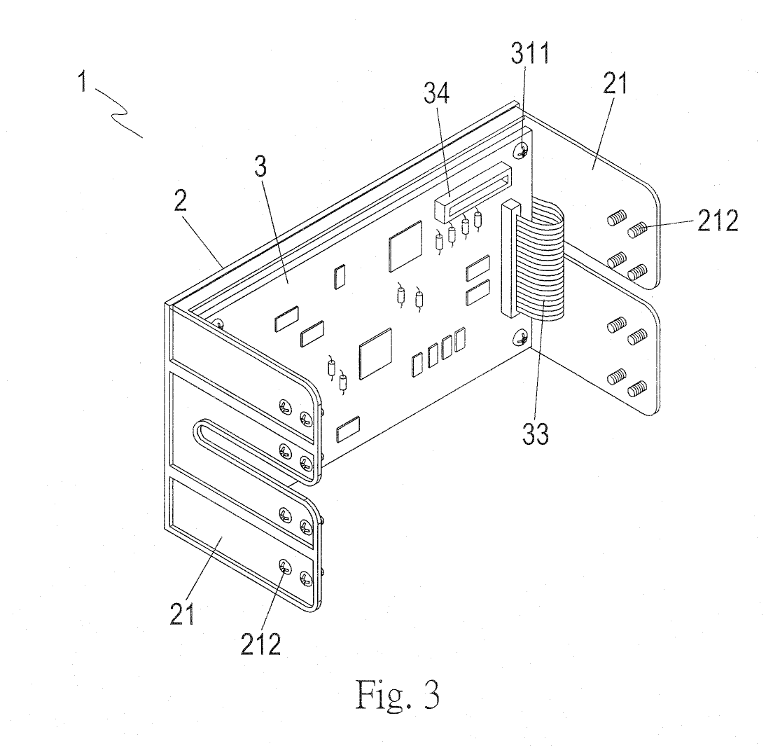

Referring to FIGS. 1 to 3, the perspective and assembled schematic view, structure exploded view and backside structural schematic view of the present invention are illustrated. The present invention relates to a personal computer monitoring assembly which comprises the following elements.

A retaining seat 2 is installed at a receiving slot 52 of a casing panel 51 of a personal computer 5. Each of two sides of the retaining seat 2 is extended with an extension portion 21 which can be embedded into the receiving slot 52. A front end of the retaining seat 2 has an opening 22 for receiving a monitoring display panel 32 so that the user can operate the monitoring display panel 32. A backside of the retaining seat 2 is installed with a locking unit 23 for locking a circuit substrate 3 and a touch panel 4. The extension portion 21 is formed with a plurality of threaded holes 211. Screws 212 screw into the screw holes 211 to lock the retaining seat 2 to the receiving slot 52 of the personal computer 5.

The circuit substrate 3 is formed with locking holes 31. Screws pass through the locking holes 31 and screw into the locking unit 23 so as to fix the circuit substrate 3 to the retaining seat 2. A front side of the circuit substrate 3 is installed with the monitoring display panel 32 to provide the function of displaying. A wire bus 33 is extended from the circuit substrate 3 and is connected to the touch panel 4. A circuit interface 34 serves to be connected to a computer mother board (not shown) for controlling and data transfer. The monitoring display panel 32 is for example a liquid crystal stacking backlight panel.

A touch panel has a plurality of micro switch touch sensitive points for providing the user to operate the monitoring display panel 32.

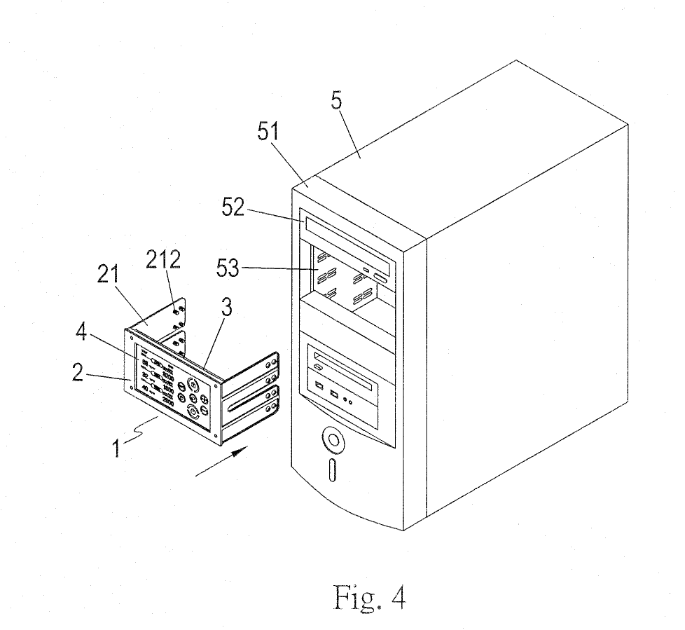

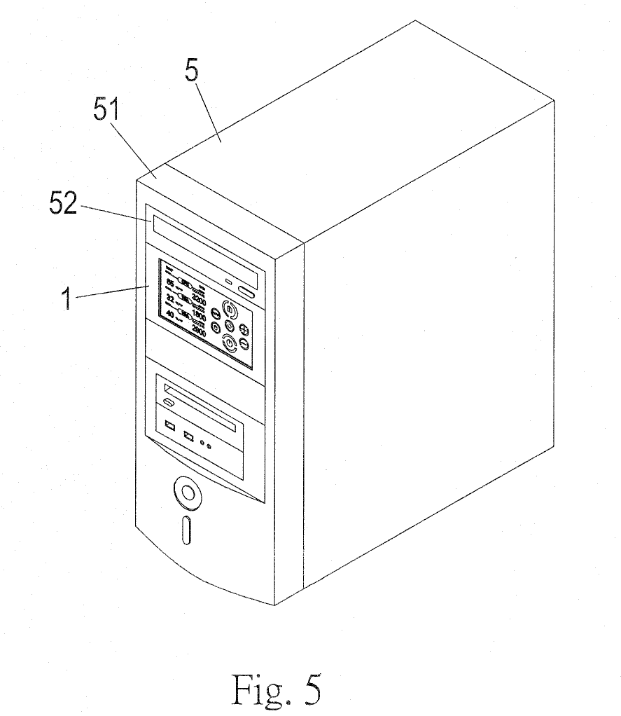

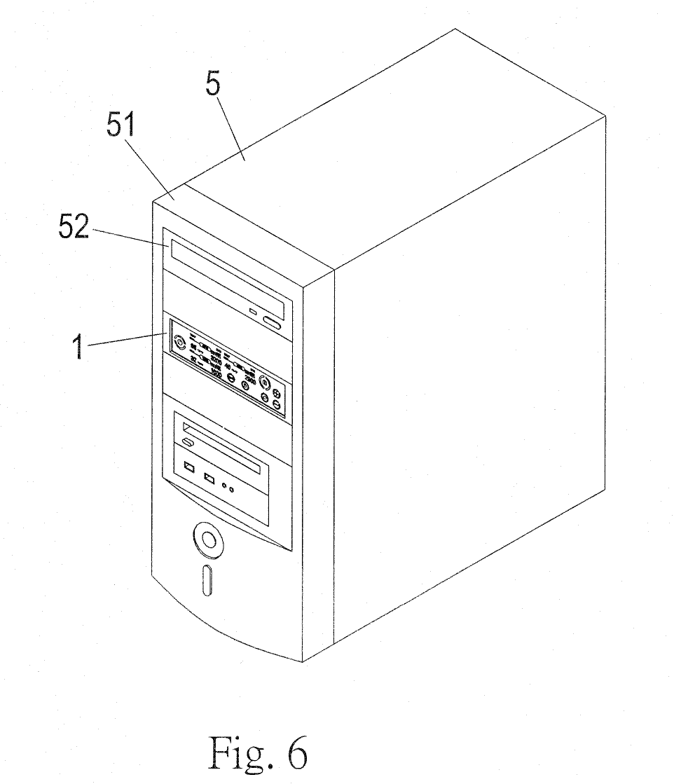

With reference to the FIGS. 4 to 6, an installation schematic view, an installation view of an embodiment, and an installation view of another embodiment of the present invention are illustrated. The retaining seat 2 is installed and screwed to a casing panel 51 of a personal computer 5 through the plurality of screws 212 screwed into a supporting frame 53 of the personal computer 5 so that a proper and larger space is formed for operating the monitoring assembly. Moreover, in installation, the retaining seat 2 of the present invention needs two 5.25 inches receiving slots (shown in FIG. 5) or one 5.25 inches receiving slot (shown in FIG. 6) of the casing panel 51 of the personal computer 5. It can also be arranged into one or several 3.5 inches receiving slots and through installing the retaining seat 2 to the casing panel. The user can easily monitors and operates the personal computer monitoring assembly of the present invention.

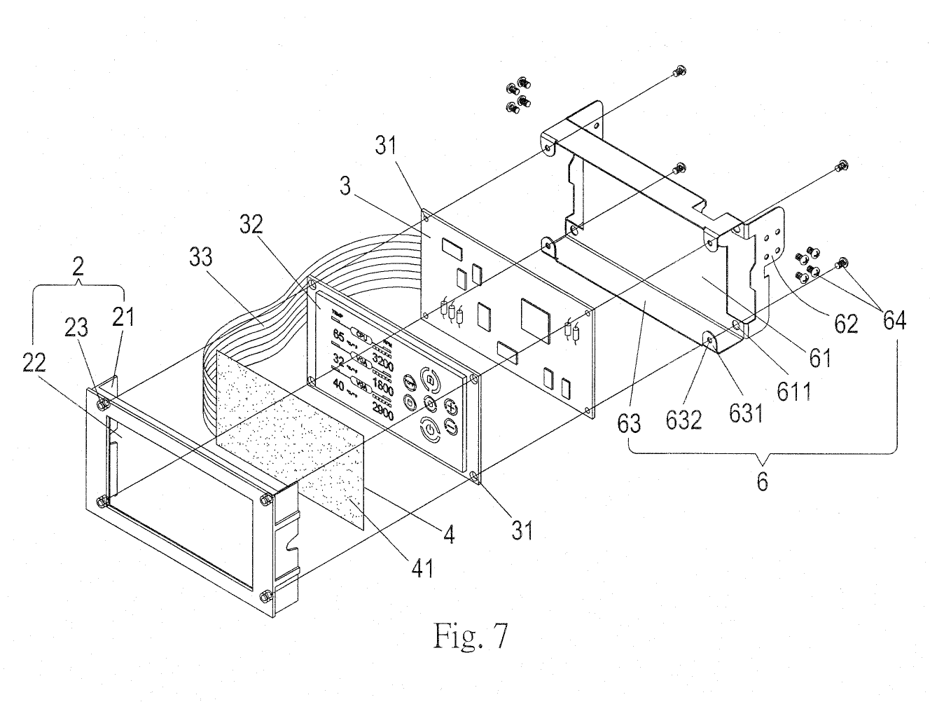

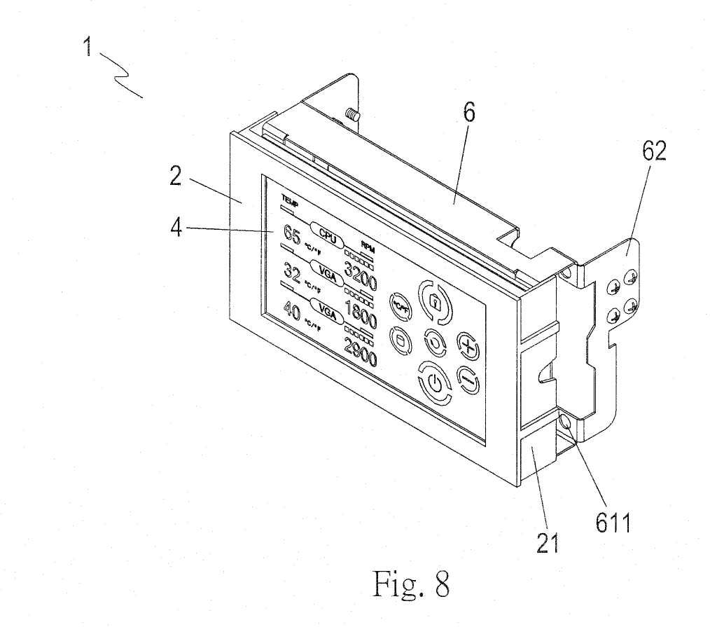

Referring to FIGS. 7 and 8, another structural exploded view, and perspective and assembled schematic view of the present invention are illustrated. A cartridge seat 6 is arranged at a back side of the retaining seat 2. At each of a right and left edge of a flat seat plate 61 of the cartridge seat 6, an ear portion 62 with threaded holes 621 is extended. Each of an upper and a lower edge of the seat plate 61 is extended a horizontal folded edge 63. Each of a left end and a right end of the horizontal folded edge 63 inwards extends with a vertical folded edge 631. A small through hole 632 is formed on each vertical folded edge 631. Large through holes 611 corresponding to each of the small through hole 632 are formed on the seat plate 61 so that screws can pass through the big through holes 611 and the small through holes 632 of the vertical folded edge 631, and the screws also pass through the locking holes 31 of the circuit plate 3 and are screwed and fixed into the locking unit 23 of the retaining seat 2.

For revealing the improvement and practicability of the present invention, the advantage of the present invention is listed in the following.

1. The present invention is installed to an upper side of a computer casing and the retaining seat is installed to the casing panel of the computer, the user can easily monitor and operate the personal computer monitoring assembly of the present invention.

2. The status of the computer can be shown on the present invention instead of the screen of the computer, the user can see the status immediately so as to increase the efficiency of a work.

3. It is convenient that the user can install and replace the present invention by themselves.

4. The present invention can meet the needs and is useful in business and the industry.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A personal computer monitoring assembly embedded to a personal computer with a touch-controlling retaining seat for increasing a touch-controlling operation space comprising:
a retaining seat installed in at least one receiving slot of a personal computer and embedded into the receiving slot through an extension portion formed on two sides of the retaining seat; a front end of the retaining seat having an opening for receiving a monitoring display panel and for touch-controlling functions of the monitoring display panel; a back side of the retaining seat having a locking unit for locking a circuit substrate and a touch panel;
a circuit substrate formed with locking holes; a front side of the circuit substrate installing with the monitoring display panel for providing a function of displaying, and a wire bus extending from the circuit substrate being connected to the touch panel; a circuit interface for connecting with to a computer mother board for controlling and data transfer; and
a touch panel having a plurality of micro switch touch sensitive points for providing the user to operate the monitoring display panel.

2. The personal computer monitoring assembly as claimed in claim 1, wherein the extension portion of the retaining seat is formed as threaded holes for locking the retaining seat to a receiving slot of a personal computer.

3. The personal computer monitoring assembly as claimed in claim 1, wherein the monitoring display panel is a liquid crystal stacking backlight panel.

4. The personal computer monitoring assembly as claimed in claim 1, wherein a cartridge seat is arranged at a back side of the retaining seat; each of a right and a left edge of a flat seat plate of the cartridge seat is formed with an ear portion with threaded holes therein; each of an upper and a lower edge of the seat plate is formed with a horizontal folded edge; each of a right end and a left end the horizontal folded edge inwards extends with a vertical folded edge; a small through hole is formed on each vertical folded edge; large through holes corresponding to each of the small through hole are formed on the seat plate so that screws will pass through the big through holes and the small through holes of the vertical folded edge, and the screws will also pass through the locking holes of the circuit plate and will be screwed and fixed into the locking unit of the retaining seat.
